(19) United States
(12) Patent Application Publication
(10) Pub. No.: US 2006/0257625 A1
(43) Pub. Date: Nov. 16, 2006

(54) Resin composite film

(76) Inventor: Yasuhiro Wakizaka, Tokyo (JP)

Correspondence Address: BIRCH STEWART KOLASCH & BIRCH, PO BOX 747, FALLS CHURCH, VA, 22040-0747, US

(21) Appl. No.: 10/571,135

(22) PCT Filed: Sep. 6, 2004
(86) PCT No.: PCT/JP04/13271

§ 371 Date: Mar. 9, 2006

(30) Foreign Application Priority Data
Sep. 10, 2003 (JP) 2003-319031

(51) Int. Cl. B32B 15/08; B32B 27/00; B05D 3/10; B05D 3/02

(52) U.S. Cl. 428/141; 428/220; 428/339; 428/411.1; 428/457; 427/372.2; 427/337

(57) ABSTRACT

To provide a resin composite film which is assured of high insulating performance and excellent mechanical properties, to allow for bending, and gives a flexible printed circuit excellent in the adhesive property. A resin composite film comprising a resin A layer having formed on at least one surface thereof a resin B layer, wherein the thickness of the resin B layer is from 0.1 to 4 μm and the resin B layer comprises an insulating material capable of giving a film having a thickness of 10 μm and a water absorptivity of 0.03 to 0.25%. When a metal layer is formed on the resin B layer surface of this resin composite film, a metal-resin composite film is obtained.

### TECHNICAL FIELD

The present invention relates to a resin composite film suitable, as examples, as a wiring film for a semiconductor package, a film for a flexible printed circuit and a wiring film for semiconductor chip mounting.

### BACKGROUND ART

A flexible printed circuit obtained by laminating a roughened copper foil on a polyimide film through an epoxy-based adhesive or a polyimide adhesive has excellent flexibility. By utilizing this advantage, the flexible printed circuit has been used as the flex portion of a rigid-flex board connecting a circuit board and a circuit board or as a tape for tape automated bonding (TAB) in the fields of cellular phones, digital cameras, LCD displays, and the like, where the board must be placed in a small space.

However, such a flexible printed circuit uses a roughened copper foil and therefore, formation of a fine line is difficult. When a copper foil having a small roughness is used for forming a fine line, the adhesion between the copper and the adhesive cannot be ensured and this causes a problem such as separation of the mounted component.

In order to solve such a problem, there has been proposed a metal-resin composite film obtained by sputtering an Ni—Cr alloy on the smooth surface of a polyimide film to form a seed layer, then forming a copper thin-film layer on the seed layer by sputtering, and growing copper on the copper foil thin-film layer by electroplating. This composite film is practically used in some electronic devices.

However, when a metal layer is provided directly on a polyimide film, the insulation resistance tends to be worsened and this is a serious problem in recent electronic components required to allow for high-density, high-voltage integration.

Under these circumstances, several methods for solving such a problem have been proposed. For example, Japanese Unexamined Patent Publication (Kokai) No. 2003-179357 discloses a method of providing a water vapor-blocking layer comprising an inorganic insulating film between a polyimide film and a metal layer.

Also, Kokai No. 11-129399 discloses a method for solving the worsening of insulation resistance resulting from the formation of a metal layer directly on a polyimide film which is a condensation polymer, where a resin composite film comprising a film formed from a ring-opened or addition polymer of a monomer having a ring structure or a modified product of the polymer (hereinafter referred to as a “ring structure-containing polymer film”) and a film formed from a polycondensation polymer is used in place of the polyimide film and a metal layer is formed on the ring structure-containing polymer film side of the resin composite film, thereby obtaining a metal-resin composite film.

### DISCLOSURE OF THE INVENTION

However, the technique disclosed in Kokai No. 2003-179357 has been found to readily cause separation between the inorganic insulating film and the polyimide film. The present inventors have realized that this separation is attributable to the formation of a water vapor-blocking layer comprising an inorganic insulating film having almost no water absorbing property on a polyimide film having a water absorbing property. Also, it has been found that, when the resin composite film described in Kokai No. 2003-179357 is largely bent, the film ruptures because the inorganic insulating film has a small tensile elongation at break.

On the other hand, when the resin composite film described in Kokai No. 11-129399 is used, a flexible printed circuit assured of high insulating performance and excellent mechanical properties allowing for bending can be obtained. However, in recent years, a method of mounting a semiconductor chip under high temperature and applied pressure is sometimes employed and the present inventors have found that under the conditions of high temperature and applied pressure, separation of the layer comprising a ring structure-containing polymer film from the metal layer also occurs. The present inventors have presumed that this separation is caused because the thickness of the ring structure-containing polymer film is 5 μm or more.

The present inventors have made intensive studies to obtain a resin composite film ensuring excellent adhesion to a metal layer even under the conditions of high temperature and applied pressure. As a result, it has been found that a resin composite film assured of excellent adhesion to a metal layer even under the conditions of high temperature and applied pressure can be obtained by using a resin composite film having a resin A layer and a resin B layer, where the resin B layer has a thickness controlled to a specific range and uses an insulating material having a specific water absorptivity. The present invention has been accomplished based on this finding.

In particular, when the resin B layer has an elongation at break in a specific range, a resin composite film with excellent mechanical properties, and allowing bending, can be obtained.

Also, a resin composite film obtained by coating an insulating material comprising an insulating polymer and a curing agent on a resin A layer to obtain an uncured or semi-cured resin layer, bringing a compound having a metal-coordinatable structure into contact with this resin layer, heating the resin layer to form a resin B layer, and providing a metal layer by a plating method on the resin B layer formed on the resin A layer is excellent in the adhesion of the metal layer, despite a smooth interface between the resin B layer and the metal layer, and enables high-density wiring formation by virtue of the smooth interface.

That is, according to the present invention, a resin composite film comprising a resin A layer formed on at least one surface of a resin B layer is provided, wherein the thickness of the resin B layer is from 0.1 to 4 μm, and the insulating material constituting the resin B gives a water absorptivity of 0.03 to 0.25%, when the thickness is 10 μm. Incidentally, the water absorptivity as used in the present invention means a water absorptivity of a film having a thickness of 10 μm.

Also, according to the present invention, a method for producing the above-described resin composite film is provided, comprising applying an insulating material comprising an insulating polymer and a curing agent on the resin A layer, and heating it to form a resin B layer.

Furthermore, according to the present invention, a metal-resin composite film having a metal layer on the surface of the resin B of the resin composite film is provided. This metal-resin composite film is particularly useful, as examples, as a wiring film for a semiconductor package, a film for a flexible printed circuit, and a wiring film for semiconductor chip mounting. The metal layer may be formed with a pattern.

### BEST MODE FOR CARRYING OUT THE INVENTION

In the resin composite film of the present invention, a resin B layer is formed at least on one surface of a resin A layer.

The resin A layer for use in the present invention may be formed of either a thermoplastic resin or a thermosetting resin, but in the light of obtaining satisfactory strength characteristics as a flexible printed circuit and reliability of component mounting, the resin has a glass transition temperature (Tg) of 70° C. or more, preferably 100° C. or more, more preferably 120° C. or more, or a melting point of 190° C. or more, preferably 220° C. or more, more preferably 250° C. or more. In the present invention, as for the resin A layer, one kind of a film may be used alone or a film obtained by combining and laminating the same or different kinds of films may be used. In the resin A layer obtained by combining and laminating the same or different kinds of films, a layer comprising an organic or inorganic non-woven fabric may be formed inside or on the surface where the resin B layer is not formed.

Specific examples of the resin A layer include a polyether resin such as polyphenylene oxide and polyether ketone; a polyester resin such as polyethylene terephthalate, polybutylene terephthalate, polyallylate and liquid-crystal polyester; a polyamide resin; a polysulfone resin; a polyphenylene sulfide resin; a polyamidoimide resin; and a polyimide resin. Among these, in view of mechanical strength, heat resistance and the like, a liquid-crystal polyester resin and a polyimide resin are preferred.

The thickness of the resin A layer may be selected by taking account of workability and mechanical properties required in usage and is usually from 1 to 200 μm. In the case of using the resin composite film as a wiring film for a semiconductor package or as a flexible printed circuit, the thickness of the resin A layer is suitably from 10 to 100 μm.

For the purpose of improving the adhesion between the resin A layer and the resin B layer, the surface of the resin A layer coming into contact with the resin B layer may be previously subjected to a pretreatment, for example, a treatment using a gas radical or an ion seed, such as corona discharge treatment and low-temperature or atmospheric pressure plasma treatment; a treatment using an electromagnetic wave, such as ultraviolet irradiation and electron beam irradiation; a treatment using a chemical reaction by the contact with an acidic solution or an alkaline solution; and a physical roughening treatment such as a blast treatment and a rubbing treatment.

The thickness of the resin B layer formed at least on one surface of the resin A layer is from 0.1 to 4 μm, preferably from 0.3 to 4 μm, more preferably from 0.5 to 3.5 μm. If the resin B layer is too thick, there arises a problem that the metal layer is seriously separated during mounting under high temperature and applied pressure, whereas if it is excessively thin, the insulation resistance may be worsened or the operational property at the formation of the resin B layer may be deteriorated.

The resin B layer for use in the present invention comprises an insulating material having a water absorptivity of 0.03 to 0.25%, preferably from 0.05 to 0.2%, when the film having the thickness of 10 μm is formed. If the resin B layer is formed by using an insulating material giving too high a water absorptivity in the above-described film state, the insulating performance greatly decreases, whereas if the water absorptivity is excessively low, the adhesion between the resin A layer and the resin B layer tends to decrease under the conditions of high temperature and humidity. This water absorptivity can be controlled by using a specific insulating polymer as the insulating material or further blending a curing agent or the like.

In the present invention, the water absorptivity of a 10 μm-thick film is a value calculated as follows. That is, a material used for forming the resin B layer is shaped into a film form having a thickness of 10 μm and a length and a width both of 3 cm, and if the weight when this film used as the sample is dried in an oven at 105° C. for 2 hours and then cooled to room temperature in a desiccator is W0 and the weight when this sample is subsequently dipped in distilled water at 25° C. and after 24 hours, pulled up from water, wiped with a dry cloth and immediately weighed is W1, a value calculated according to the following formula 1 is defined as the water absorptivity:
Water absorptivity=[(W1−W0)/W0]×100 (formula 1)

Furthermore, in view of flexibility of the resin composite film, the resin B layer preferably has a tensile elongation at break of 1.5% or more as measured by the following method. The tensile elongation at break is a value determined by preparing a specimen of Type 2 shape (thickness: 10 μm, width: 5 mm, length: 70 mm) from the material used for forming the resin B layer and measuring the specimen according to the test method prescribed in JIS K 7127-1999 with an inter-marker distance of 50 mm, an initial distance of 50 mm between chucks and a test speed of 20±2.0 mm/min.

As for the method of forming the resin B layer in the present invention, for example, an insulating material comprising an insulating polymer and a curing agent is used.

Examples of the insulating polymer include an epoxy resin, a maleimide resin, an acrylic or methacrylic resin, a diallyl phthalate resin, a triazine resin, an alicyclic olefin polymer, an aromatic polyether polymer, a benzocyclobutene polymer and a cyanate ester polymer. Among these, in view of low water absorbing property, an alicyclic olefin polymer, an aromatic polyether polymer, a benzocyclobutene polymer and a cyanate ester polymer are preferred, an alicyclic olefin polymer and an aromatic polyether polymer are more preferred, and an alicyclic olefin polymer is still more preferred.

The weight average molecular weight Mw of the insulating polymer is not particularly limited but, usually, the weight average molecular weight is suitably from 10,000 to 500,00, preferably from 30,000 to 300,000, because the resin B layer can be prevented from roughening due to the pretreatment at the time of performing plating treatment afterward and, also, excellent mechanical properties as a resin composite film can be obtained.

Here, the weight average molecular weight Mw as used in the present invention is a weight average molecular weight in terms of polystyrene or polyisoprene measured by gel permeation chromatography (GPC).

The alicyclic olefin polymer which is a particularly preferred insulating polymer is a polymer of an unsaturated hydrocarbon having an alicyclic structure. Specific examples of the alicyclic olefin polymer include a ring-opened polymer of a norbornene monomer or a hydrogenated product of the polymer, an addition polymer of a norbornene monomer, an addition polymer of a norbornene monomer and a vinyl compound, a monocyclic cycloalkane polymer, an alicyclic conjugated diene polymer, a vinyl alicyclic hydrocarbon polymer or a hydrogenated product thereof, and an aromatic ring-hydrogenated product of an aromatic olefin polymer. Among these, a ring-opened polymer of a norbornene monomer or a hydrogenated product of the polymer, an addition polymer of a norbornene monomer, an addition polymer of a norbornene monomer and a vinyl compound, and an aromatic ring-hydrogenated product of an aromatic olefin polymer are preferred, and a hydrogenated ring-opened polymer of a norbornene monomer is more preferred.

The alicyclic olefin polymer preferably has a polar group. Examples of the polar group include a hydroxyl group, a carboxyl group, an alkoxyl group, an epoxy group, a glycidyl group, an oxycarbonyl group, a carbonyl group, an amino group, an ester group and a carboxylic acid anhydride group. Among these, a carboxyl group and a carboxylic acid anhydride (carbonyloxycarbonyl) group are preferred.

The alicyclic olefin polymer is usually obtained by addition polymerizing or ring-opening polymerizing a norbornene monomer having a norbornene ring, such as 8-ethyl-tetracyclo[4.4.0.1^{2,5}.1^{7,10}]-dodec-3-ene and tricyclo[4.3.0.1^{2,5}]deca-3,7-diene, if desired, together with other monomers, and if desired, hydrogenating the unsaturated bond moiety, or by addition polymerizing an aromatic olefin and hydrogenating the aromatic ring moiety of the polymer. The alicyclic olefin polymer having a polar group is obtained, for example, (1) by incorporating a polar group into the above-described alicyclic olefin polymer through a modification reaction or (2) by copolymerizing a monomer having a polar group as a copolymerization component. Also, in the alicyclic olefin polymer having a polar group, (3) after copolymerizing a monomer having a polar group (e.g., ester group) as a copolymerization component, the polar group may be converted by hydrolyzing the ester group or the like.

Furthermore, the alicyclic olefin polymer may also be obtained by copolymerizing an alicyclic olefin and/or an aromatic olefin and a monomer copolymerizable therewith (e.g., 1-hexene).

The glass transition temperature of the alicyclic olefin polymer may be appropriately selected according to the intended use but is usually 50° C. or more, preferably 70° C. or more, more preferably 100° C. or more, and most preferably 125° C. or more.

The curing agent is not particularly limited as long as a crosslinked structure is formed under heating and curing is effected. As for the curing agent, a known heat curing agent such as an ionic curing agent, a radical curing agent and a curing agent having both ionic property and radical properties, may be used. In particular, a glycidyl ether-type epoxy compound such as bisphenol A bis(propylene glycol glycidyl ether)ether, or a polyvalent epoxy compound such as alicyclic epoxy compound and glycidyl ester-type epoxy compound, is preferably used as the curing agent, because a water absorptivity with a 10 μm-thick film in the above-described range can be obtained. The blending ratio of the curing agent is usually from 1 to 80 parts by weight, preferably from 5 to 60 parts by weight, more preferably from 10 to 50 parts by weight, per 100 parts by weight of the insulating polymer.

Also, a curing accelerator is preferably used together with the curing agent, because a resin B layer having high heat resistance and a low water absorptivity with a 10 μm-thick film can be easily obtained. For example, in the case of using a polyvalent epoxy compound as the curing agent, a curing accelerator such as tertiary amine compound (e.g., triazole compound, imidazole compound) and boron trifluoride complex compound, may be used.

In the insulating material, a flame retardant, a filler, a soft polymer, a heat-resistant stabilizer, weather-resistant stabilizer, an antioxidant, a leveling agent, an antistatic agent, a slipping agent, an antiblocking agent, an anticlouding agent, a lubricant, a dye, a pigment, a natural oil, a synthetic oil, a wax, an emulsion, a magnetic material, a dielectric property adjusting agent, a toughening agent or the like may be used in combination. The blending ratio of such an additive is appropriately selected within the range of not impairing the object of the present invention.

Also, in the case of obtaining the metal-resin composite film of the present invention by forming the metal layer by a plating method, a resin component or filler dissolvable in the oxidizing treatment solution used for the treatment before plating may be incorporated into the insulating material.

In order to obtain a resin B layer having the above-described water absorptivity and tensile elongation at break, an insulating material giving a percentage mass change of 0.01 to 0.5%, preferably from 0.05 to 0.3%, after dipping in an aqueous sodium hydroxide solution as measured according to JIS K7114 is suitably used. The details of evaluation of the percentage mass change are as follows.

Complying with JIS K7114:2001

Specimen: a film shaped into 60 mm×60 mm and a thickness of 1 mm

Test conditions: 70° C.±2° C., 40 mass % of NaOH aqueous solution as a test solution

Test time: 24 hours

Test method: according to Mass Change JIS K 7114:2001 5.4, Measurement of Mass Change

More specifically, the weight (m1) of the specimen is measured by adjusting the condition according to Class 2 of Atmosphere 23/50 of JIS K 7100:2001. Subsequently, the specimen is dipped in a test solution for 24 hours, pulled up, washed and dried in an oven adjusted to 50° C.±2° C. for 6 hours. Thereafter, the specimen is allowed to cool and again, the weight (m2) of the specimen is measured by adjusting the condition according to Class 2 of Atmosphere 23/50 prescribed in JIS K 7100:2001.

Percentage mass change (%)=[(m2−m1)/m1]×100

The formation method of the resin B layer is not particularly limited, but a method of adding a solvent to the insulating material to provide a varnish state and then forming the resin B layer is preferred, because good shapability is ensured. Examples of the solvent include an aromatic hydrocarbon organic solvent such as toluene, xylene, ethylbenzene and trimethylbenzene; an aliphatic hydrocarbon organic solvent such as n-pentane, n-hexane and n-heptane; an alicyclic hydrocarbon organic solvent such as cyclopentane and cyclohexane; a halogenated hydrocarbon organic solvent such as chlorobenzene, dichlorobenzene and trichlorobenzene; and a ketone organic solvent such as methyl ethyl ketone, methyl isobutyl ketone, cyclopentanone and cyclohexanone.

The method for obtaining a varnish is not particularly limited and, for example, a varnish may be obtained by mixing the above-described insulating polymer, and respective components used as desired, with an organic solvent. Respective components may be mixed by an ordinary method and, for example, the mixing may be performed by stirring with use of a stirring bar and a magnetic stirrer; or a method using a high-speed homogenizer, a disper, a planetary mixer, a biaxial mixer, a ball mill, a three-roll mill or the like. These components are preferably mixed at a temperature in the range where the reaction by the curing agent does not affect the workability and, in view of safety, more preferably at a temperature not higher than the boiling point of the organic solvent used in the mixing.

The amount of the solvent used is appropriately selected according to the purpose such as control of thickness or enhancement of flatness. The amount of the solvent is usually adjusted to give a varnish having a solid content concentration of 5 to 70 wt %, preferably from 10 to 65 wt %, more preferably from 20 to 60 wt %. When the solid content concentration of the varnish is in this range, the thickness of the resin B layer in the above-described range can be easily obtained.

The method of forming the resin B layer on at least one surface of the resin A layer by using the insulating material is not particularly limited, and an arbitrary method may be employed by taking account of the thickness of the resin B layer to be formed. Examples of the method include (1) a method of applying the insulating material in the form of a varnish on the resin A layer, performing, if desired, removal of solvent or surface treatment, and then heating to form the resin B layer, and (2) a method of shaping the insulating material into a film form, and stacking the film on the resin A layer by using, if desired, an adhesive. The method of (1) is preferred in that the resin composite film can be formed without using an adhesive and therefore, stable thermal properties or electric properties can be ensured. In the method of (2), using a supporting body comprising an arbitrary resin film or metal foil in place of the resin A layer, similarly to the method of (1) described later, the insulating layer may be coated, for example, by a melt-extrusion method or a solution casting method, subjected to, if desired, removal of solvent or surface treatment, and then heated.

In the method of (1), the method of applying the insulating material on the resin A layer is not particularly limited. Examples thereof include a melt-extrusion method and a solvent casting method. In view of operational property, the solution casting method is preferred. In the case of employing the solution casting method, the application may be performed, for example, by reverse roll coating, gravure coating, air knife coating, blade coating, dip coating, curtain coating or die coating. In particular, reverse roll coating, gravure coating and die coating are preferred, because the film thickness can be easily controlled.

Also, in the case where a solvent is added to the insulating material, drying for removing the solvent is generally performed after the application. At this time, the drying conditions are appropriately selected according to the kind of the solvent, but the drying temperature is usually from 20 to 300° C., preferably from 30 to 200° C., and the drying time is usually from 30 seconds to 1 hour, preferably from 1 to 30 minutes.

By this drying, an uncured or semi-cured resin layer is formed. When the uncured or semi-cured resin layer is heated, the resin B layer is obtained. The term “uncured” as used herein means a state where the substantially entire resin layer can be dissolved in a solvent capable of dissolving the insulating polymer used for constituting the resin layer. The term “semi-cured” means a state where the resin layer partially (about 1 wt % or more of the insulating polymer) dissolves in a solvent capable of dissolving the insulating polymer used for constituting the resin layer, or means that when the resin layer is dipped in the solvent for 24 hours, the volume swelling ratio of the resin layer is 200 vol % or more based on the volume before dipping. Particularly, in the latter case, it is preferred that the semi-cured resin layer is in a state where 5 wt % or more of the insulating polymer dissolves in a solvent capable of dissolving the insulating polymer used for constituting the resin layer, or the volume swelling ratio after the resin layer is dipped in the solvent for 24 hours is 300 vol % or more based on the volume before dipping.

By surface-treating the uncured or semi-cured resin layer, the adhesive property can be enhanced at the time of stacking a metal layer on the resin B layer later.

Examples of the surface treatment method include a method of bringing a compound having a metal-coordinatable structure into contact with the resin layer. By virtue of performing this surface treatment, when a metal layer is formed by a plating method, excellent adhesion can be obtained between the resin B layer and the metal layer, despite the smooth surface of the resin B layer.

The compound having a metal-coordinatable structure (hereinafter sometimes referred to as a “coordination structure-containing compound”) is preferably a compound having a metal-coordinatable functional group such as amino group, thiol group, carboxyl group and cyano group, or a compound containing an unshared electron pair such as heterocyclic compound having the capability of coordination to metal. In particular, a heterocyclic compound containing a nitrogen atom, an oxygen atom or a sulfur atom is preferred, and a heterocyclic compound containing a nitrogen atom is more preferred. Of course, such a heterocyclic compound may further has a metal-coordinatable functional group. The heterocyclic compound having also a metal-coordinatable functional group is preferred, because this gives a high pattern adhesive property between the resin B layer and a metal layer.

In the light of enhancing the effect of the present invention, the coordination structure-containing compound is preferably an amphipathic compound having a solubility of 0.1 wt % or more, preferably 1 wt % or more, more preferably 5 wt % or more, both in water at 25° C. and in a hydrocarbon solvent. In the case of such a compound, at the step of contacting with the uncured or semi-cured resin layer, a solution incapable of dissolving or swelling the resin layer can be selected and at the same time, impregnation into the uncured or semi-cured resin layer can be achieved, as a result, high adhesion strength to the metal layer is easily obtained.

When a coordination structure-containing compound is used, the crosslinking density on the resin layer surface can be increased at the curing of the resin layer and at the same time, the hydrophilicity can be enhanced.

Out of these compounds, preferred examples of the compound which reacts with the component in the insulating material and is firmly held on the surface of the resin substrate formed in the next step, include imidazoles such as imidazole, 2-methylimidazole, 2-ethyl-4-methylimidazole, 2-mercaptomethylbenzimidazole, 2-ethylimidazole-4-dithiocarboxylic acid, 2-methylimidazole-4-carboxylic acid, 1-(2-aminoethyl)-2-methylimidazole, 1-(2-cyanoethyl)-2-methylimidazole, 2-phenyl-4,5-dihydroxymethylimidazole, benzimidazole and 2-ethyl-4-thiocarbamoylimidazole; pyrazoles such as pyrazole and 3-amino-4-cyanopyrazole; triazoles such as 1,2,4-triazole, 2-amino-1,2,4-triazole, 1,2-diamino-1,2,4-triazole and 1-mercapto-1,2,4-triazole; and triazines such as 2-aminotriazine, 2,4-diamino-6-(6-(2-(2-methyl-1-imidazolyl)ethyl)triazine and 2,4,6-trimercapto-s-triazine-trisodium salt.

The method of bringing such a coordination structure-containing compound into contact with the uncured or semi-cured resin layer surface is not particularly limited. Specific examples thereof include a dip method of dissolving the coordination structure-containing compound in water or an organic solvent to prepare a solution, and dipping the resin composite film having formed thereon a resin layer in the prepared solution, a spray method of coating this solution on the surface of a shaped article of the resin composite film having formed thereon a resin layer by spraying or the like, and a method of applying the solution by a coating method such as reverse roll coating, gravure coating, air knife coating, blade coating, dip coating, curtain coating or die coating. The contacting operation may be performed once or may be repeated twice or more times.

The temperature at the time of contacting the compound may be arbitrarily selected by taking account of the melting point of the coordination structure-containing compound, the boiling point of the solution thereof, the operational property or the productivity, but is usually from 10 to 100° C., preferably from 15 to 65° C. In the case of contacting the compound by a dipping method, the contact time may be arbitrarily selected according to the amount of the coordination structure-containing compound to be attached to the uncured or semi-cured resin layer surface, the concentration of the solution thereof or the productivity, but is usually from 0.1 to 360 minutes, preferably from 0.1 to 60 minutes. Thereafter, preheating is preferably performed by using a drying furnace at 30 to 180° C., preferably from 50 to 150° C., for 10 seconds or more, preferably from 30 seconds to 30 minutes, to remove the solvent and, at the same time, to react the coordination structure-containing compound with the component in the uncured or semi-cured resin layer, thereby preventing volatilization of the resin during curing.

The coordination structure-containing compound is used, if desired, after dissolving it in a solvent. The solvent used here is not particularly limited, and a solvent in which the uncured or semi-cured resin layer, after being stacked on the resin A layer, does not easily dissolve and the coordination structure-containing compound does dissolve may be selected. Examples thereof include a polar solvent such as water; ethers such as tetrahydrofuran; alcohols such as ethanol and isopropyl alcohol; ketones such as acetone; and cellosolves such as ethyl cellosolve acetate. One solvent may be used alone or two or more kinds of solvents may be used in combination. In the case of dissolving the coordination structure-containing compound in a solvent, the concentration of the coordination structure-containing compound is not particularly limited but, in view of operational property, usually from 0.001 to 70 wt %, preferably from 0.01 to 50 wt %.

Of course, when the coordination structure-containing compound is in a liquid state at the temperature of use and the operation of bringing the coordination structure-containing compound into contact with the uncured or semi-cured resin layer surface is not hindered, the coordination structure-containing compound may be used as it is without particularly dissolving it in a solvent.

In the present invention, as the component other than the coordination structure-containing compound, a surfactant used for the purpose of enhancing the wetting of the uncured or semi-cured resin layer to the coordination structure-containing compound solution, and other additives may be blended in the coordination structure-containing compound solution. In the light of ensuring adhesive property, the amount used, of such a component other than the coordination structure-containing compound, is 10 wt % or less, preferably 5 wt % or less, more preferably 1 wt % or less, based on the coordination structure-containing compound.

In the case where the uncured or semi-cured resin layer is surface-treated, the surface of the resin layer before heating may be washed with water or an organic solvent to remove the excess surface treating agent or effect neutralization. For example, when the surface treating agent is a coordination structure-containing compound and is basic, the neutralization can be effected by contacting the resin layer with an acidic compound.

After the insulating material is coated and dried to obtain an uncured or semi-cured resin layer and, if desired, the resin layer is surface-treated, heating is usually performed to cure the resin layer, whereby the resin B layer is obtained.

In the heating performed for curing, the uncured or semi-cured resin layer obtained on the resin A layer by applying the insulating material (or the entirety of the film having formed thereon the resin layer) is usually heated by using an oven, a hot plate or a heating furnace. The heating temperature is appropriately selected according to various conditions such as the kind of insulating polymer or curing agent, the thickness of resin layer and the heating method, but the heating temperature is usually from 30 to 400° C., preferably from 70 to 350° C., more preferably from 100 to 250° C. The heating time may also be set by taking account of the heating method or the like but is usually from 30 seconds to 180 minutes, preferably from 3 to 90 minutes.

In this way, a resin composite film comprising a resin A layer and a resin B layer is obtained. The production process of the resin composite film may be performed by batch processing but is preferably performed continuously by forming the film as a roll.

The metal-resin composite film of the present invention is obtained by forming a metal layer on the resin B layer of the resin composite film of the present invention. Particularly, according to the plating method which is described in detail later, a metal layer with high adhesive property can be formed on the smooth resin B layer.

Also, in the case where the resin composite film of the present invention is used as a wiring board by forming an electrically conducting circuit on both surfaces thereof, after the metal layer is formed, a wiring connection may be applied by forming an opening (via hole) through physical processing such as drilling, laser and plasma etching and forming an electrically conducting film on the wall surface of the opening. Furthermore, when an opening is formed in the resin composite film by physical processing such as drilling, laser and plasma etching before forming the metal layer and then the metal layer is formed by a plating method, the metal layer can be formed en bloc on the wall surface of the opening and on the surface of the resin composite film and an inexpensive double-sided wiring board can be produced.

The metal layer may cover the entire surface of the resin B layer but may also be formed to have a wiring pattern.

In the case of using the metal-resin composite film of the present invention as an electronic circuit board, the metal used for constituting the metal layer is a metal having resistivity of less than 1×10⁻² Ωcm at 20° C., and specific examples thereof include copper, aluminum, nickel, gold, silver, chromium and an alloy thereof. The metal layer may be a single layer or may comprise two or more layers stacked by using the same or different metal species.

The thickness of the metal layer is not particularly limited, but considering the convenience of transportation, the thickness is preferably in the range allowing it to be taken up into a roll. The thickness of the metal layer is usually from 0.05 to 100 μm. If the thickness is less than this lower limit, the metal layer may be damaged due to friction or rubbing at the time of taking up the film into a roll, whereas if it exceeds the upper limit, the taking-up becomes difficult. Particularly, in the case of forming a fine pattern as an electronic circuit board, the thickness of the metal layer is preferably from 0.05 to 9 μm. If the thickness is less than this lower limit, the circuit may be damaged, whereas if it exceeds the upper limit, the etching precision with a wiring width of less than 20 μm can be hard to control.

In the case of forming the metal layer by a plating method, the resin B layer surface which is surface-treated with the coordination structure-containing compound is preferably subjected to an oxidation treatment as a plating pretreatment so as to enhance the adhesive property to the metal layer.

By oxidizing the resin B layer surface, the surface ten-point average roughness Rzjis can be adjusted to 3 μm or less, preferably 2 μm or less, and the surface roughness Ra can be adjusted to 0.2 μm or less, preferably 0.1 μm or less. Here, Ra is a centerline average roughness prescribed in JIS B 0601-2001, and the surface ten-point average roughness Rzjis is a ten-point average roughness prescribed in JIS B 0601-2001, Appendix 1.

Usually, when the resin B layer surface is oxidized by using a gaseous medium or an oxidizing treatment solution, the surface becomes brittle and satisfactory adhesion to metal can be hardly obtained. However, by passing through a surface treatment step using the above-described coordination structure-containing compound, a strong resin substrate surface can be obtained, and by virtue of the oxidation treatment, the brittle layer comprising a low molecular weight compound produced on the resin B layer surface or the contaminant attached from the curing atmosphere can be removed.

As for the method for oxidation treatment using a gaseous medium, a known plasma treatment capable of converting the medium into a radical or an ion, such as reverse sputtering and corona discharge, may be used. Examples of the gaseous medium include air, oxygen, nitrogen, argon, water, carbon disulfide, carbon tetrachloride and a mixed gas thereof. In the case where the medium is a liquid at the treatment temperature, the medium is gasified under reduced pressure and then used for the oxidation treatment. In the case where the medium is a gas at the treatment temperature, the medium is pressurized to a pressure capable of converting it into a radical or an ion and then it is used for the oxidation treatment. The temperature and time period on contacting the plasma with the resin B layer surface may be arbitrarily set by taking account of the kind of gas or the flow rate. The temperature is usually from 10 to 250° C., preferably from 20 to 180° C., and the contact time is usually from 0.5 to 60 minutes, preferably from 1 to 30 minutes.

In the present invention, in the case of oxidizing the resin B layer surface by using an oxidizing treatment solution, this is performed by contacting the resin B layer surface with an oxidizing treatment solution (an oxidizing compound in the liquid form or a solution of an oxidizing compound).

The oxidizing compound is preferably, for example, an inorganic peroxide or an organic peroxide, because the surface roughness of the resin B layer can be easily controlled.

Examples of the inorganic peroxide include permanganate, chromic anhydride, bichromate, chromate, persulfate, active manganese dioxide, osmium tetroxide, hydrogen peroxide, periodate and ozone. Examples of the organic peroxide include dicumyl peroxide, octanoyl peroxide, m-chloroperbenzoate and peracetic acid.

The method of oxidizing the resin B layer surface by using an inorganic peroxide or an organic peroxide is not particularly limited and, for example, a general method such as a method of bringing an oxidizing compound or, if desired, an oxidizing treatment solution obtained by dissolving an oxidizing compound in a medium capable of dissolving it, into contact with the resin B layer, may be employed. Examples of the medium used for dissolving an inorganic peroxide or an organic peroxide include a neutral water, an alkali aqueous solution such as aqueous sodium hydroxide solution, an acidic aqueous solution such as aqueous sulfuric acid solution, a nonpolar organic solvent such as ether and petroleum ether, and a polar organic solvent such as acetone and methanol. The method of bringing an inorganic peroxide, an organic peroxide or a solution thereof into contact with the resin B layer surface is not particularly limited, and any method may be used, such as a dipping method of dipping the resin composite film in an oxidizing treatment solution, a liquid mounting method of mounting an oxidizing treatment solution on the resin B layer surface by utilizing the surface tension, and a spray method of spraying an oxidizing treatment solution on the resin B layer surface.

The temperature and time period on contacting such an inorganic peroxide or organic peroxide with the resin B layer surface are set by taking account of, for example, the concentration or kind of the peroxide or the contacting method. The contact temperature is usually from 10 to 250° C., preferably from 20 to 180° C., and the contact time is from 0.5 to 60 minutes, preferably from 1 to 30 minutes. Within these ranges, the roughening degree of the resin B layer surface can be easily controlled, removal of the brittle layer on the resin B layer or the contaminant attached in the curing step is facilitated, and the resin B layer surface can be prevented from becoming brittle.

In the case of oxidizing the resin B layer surface by using an oxidizing treatment solution, the surface roughness may also be controlled by incorporating a resin or filler soluble in the oxidizing treatment solution into the insulating material constituting the resin B layer.

As for such a resin, a resin capable of forming a fine sea island structure with the curable resin composition and dissolving it in the oxidation treatment solution used may be appropriately selected. This resin may be used as a part of the insulating polymer. Specific examples of the resin include epoxy resin, polyester resin, bismaleimide-triazine resin, silicone resin, polymethyl methacrylate, natural rubber, styrene-based rubber, isoprene rubber, butadiene rubber, ethylene-based rubber, propylene-based rubber, urethane rubber, butyl rubber, silicone rubber, nitrile rubber, fluororubber, norbornene rubber and ether-based rubber.

The blending ratio of the resin soluble in the oxidizing treatment solution is appropriately selected according to the degree of formation of a fine sea island structure with the insulating polymer constituting the resin B layer, but the blending ratio is usually from 1 to 100 parts by weight, preferably from 3 to 50 parts by weight, more preferably from 5 to 20 parts by weight, per 100 parts by weight of the insulating polymer. Within this range, a fine roughness profile and a uniform adhesive property are readily obtained.

As for the filler, a filler dissolvable in the oxidizing treatment solution used may be appropriately selected, and an inorganic filler or an organic filler may be used.

Examples of the inorganic filler include calcium carbonate, magnesium carbonate, barium carbonate, zinc oxide, titanium oxide, magnesium oxide, magnesium silicate, calcium silicate, zirconium silicate, hydrated alumina, alumina, magnesium hydroxide, aluminum hydroxide, barium sulfate, silica, talc and clay. Among these, calcium carbonate and silica are preferred for obtaining a fine roughness surface profile, because a fine particle is easily obtained and such a filler is readily dissolved out by a filler soluble aqueous solution. Also, the inorganic filler may be treated with a silane coupling agent or an organic acid such as stearic acid.

Examples of the organic filler include a particulate compound of epoxy resin, polyester resin, bismaleimide-triazine resin, silicone resin, polymethyl methacrylate, natural rubber, styrene-based rubber, isoprene rubber, ethylene-based rubber, propylene-based rubber, urethane rubber, butyl rubber, silicone rubber, nitrile rubber, fluororubber, norbornene rubber or ether-based rubber.

Also, the filler is preferably a non-electrically conducting filler which does not reduce the dielectric properties of the resin B layer. The shape of the filler is not particularly limited and, for example, may be spherical, fibrous or plate-like, but in order to obtain a resin B layer surface having a fine roughness profile, the filler is preferably in a fine powder form. The average particle diameter of the filler is usually from 0.008 to 2 μm, preferably from 0.01 to 1.5 μm, more preferably from 0.02 to 1 μm. If the particle diameter is less than this range, uniform adhesion in the entire roll may not be obtained, whereas if it exceeds this range, a large roughness may be generated in the resin B layer surface profile and a high-density wiring may not be obtained.

The blending ratio of the filler is appropriately selected according to the required degree of adhesion but is usually from 1 to 80 parts by weight, preferably from 3 to 60 parts by weight, more preferably from 5 to 40 parts by weight, per 100 parts by weight of the insulating polymer. Within this range, a fine roughness profile and a uniform adhesive property are readily obtained. Such a filler may be used as a part of the flame retardant, heat-resistant stabilizer, dielectric property adjusting agent or toughening agent added to the insulating material.

After the oxidation treatment, the resin B layer surface is usually washed with water to remove the excess oxidizing compound or the treatment residue. In the case where a substance not cleanable by water is attached, washing with a cleaning solution capable of dissolving the substance may be performed or, after chemically changing the substance into a water soluble substance by the contact with another compound, washing with water may be performed. Specific examples of such a method include, when an alkaline aqueous solution such as aqueous potassium permanganate solution or aqueous sodium permanganate solution is contacted with the resin substrate, a method of performing a neutralization-reduction treatment with an acidic aqueous solution such as a mixed solution of hydroxyamine sulfate and sulfuric acid for the purpose of removing the manganese dioxide film generated, and when the curable resin composition contains calcium carbonate and the calcium carbonate remains on the resin surface layer, a method of dissolving out the calcium carbonate with an acidic solution such as hydrochloric acid and sulfuric acid and then performing the washing treatment with water. In the cleaning solution, a surfactant or a polarity adjusting agent such as alcohol and ether may be used for achieving satisfactory cleaning. However, when a surfactant or a polarity adjusting agent is used, this additive is preferably removed by further performing washing.

As for the method of forming the metal layer, for example, a method of laminating the metal layer in the state of the resin B layer heated to a temperature of Tg or more, or a method of applying a solution comprising an electrically conducting particle and a dispersant, and removing the dispersant by drying under heat to form the metal layer may be used, but a plating method is preferred in view of control of the metal layer thickness or adhesive property.

The method of forming the metal layer by a plating method is not particularly limited, and examples thereof include a method of forming a metal thin film layer of the metal layer by sputtering, vacuum deposition, CVD and the like which are dry plating, and then forming the metal layer by electroplating utilizing the thin film layer; a method of forming the metal layer by electroless plating which is wet plating; a method of forming a metal thin film layer as a part of the metal layer by electroless plating which is wet plating, and then performing electroplating utilizing the thin film layer to complete the metal layer; a method of adsorbing an electrically conducting particle such as palladium particle and graphite particle, and then forming the metal layer by electroplating utilizing the electrically conducting film; and a method of forming an electrically conducting polymer film by oxidation-polymerizing a monomer capable of forming an electrically conducting polymer, in the presence of an oxidizing film produced by a treatment with a inorganic peroxide salt such as permanganate, and then forming the metal layer by electroplating utilizing the electrically conducting film. Among these methods, a method of forming a metal thin film by electroless plating which is wet plating, and then forming the metal layer by electroplating utilizing the thin film layer is preferred, because this method is inexpensive and a high density can be stably obtained.

In the case of forming a metal thin film layer by electroless plating which is wet plating, the metal thin film is generally formed on the resin B layer surface after adsorbing a catalyst nucleus working as a reduction catalyst, such as silver, palladium, zinc, cobalt, gold, platinum, iridium, ruthenium and osmium, on the resin layer.

The method for attaching a catalyst nucleus on the resin B layer is not particularly limited and, for example, a method of dissolving a metal compound such as silver, palladium, zinc, cobalt, gold, platinum, iridium, ruthenium and osmium, or a salt or complex thereof in water or an organic solvent such as alcohol and chloroform to a concentration of 0.001 to 10 wt % (if desired, the solution may contain an acid, an alkali, a complexing agent, a reducing agent or the like), dipping the resin layer in the resulting solution and then reducing the metal, may be employed.

As for the electroless plating solution used in the electroless plating method, a known self-catalyst type electroless plating solution may be used, and the metal species, reducing agent species, complexing agent species, hydrogen ion concentration, dissolved oxygen concentration and the like are not particularly limited. Examples of the electroless plating solution which can be used include an electroless copper plating solution using ammonium hypophosphite, hypophosphorous acid, ammonium boron hydride, hydrazine, formalin or the like as the reducing agent, an electroless nickel-phosphorus plating solution using sodium hypophosphite as the reducing agent, an electroless nickel-boron plating solution using dimethylamineborane as the reducing agent, an electroless palladium plating solution, an electroless palladium-phosphorus plating solution using sodium hypophosphite as the reducing agent, an electroless gold plating solution, an electroless silver plating solution, and an electroless nickel-cobalt-phosphorus plating solution using sodium hypophosphite as the reducing agent.

Also, the same kind of metal may be formed multiple times by repeating the electroless plating, or a plurality of different metals may be superposed.

The thickness of the metal formed by the electroless plating method may be arbitrarily determined by taking account of the thickness of the metal. In general, considering the subsequent growth of an electroplating metal layer, the thickness is preferably from 0.01 to 0.5 μm, more preferably from 0.03 to 0.3 μm, still more preferably from 0.05 to 0.15 μm. If the thickness exceeds this range, there arises a problem that the adhesive property decreases due to high film stress characteristic of the electroless plating or that the plating takes time and the profitability is low, whereas if the thickness is less than the above-described range, this causes a problem that the metal thin film dissolves out in the pretreatment or processing step at the time of performing electroplating by utilizing the electroless plating film and a uniform metal layer can be hardly formed.

After forming the metal thin film layer, a rust preventive treatment may be performed by contacting the resin composite film surface with a rust inhibitor.

On the thus-obtained metal thin film layer, plating is grown, if desired, whereby the metal-resin composite film is completed. As for the electroplating, plating utilizing an electrodeposition reaction of metal in an aqueous solution may be employed, and the electroplating may be performed according to a normal method by using a copper sulfate plating solution, a copper pyrophosphate, an electrolytic nickel plating solution or the like. If desired, the electroplating solution may contain an additive such as complexing agent, brightening agent, stabilizer and buffer. Subsequently, a rust preventive treatment may be performed by contacting the resin composite film surface with a rust inhibitor.

In the case of forming the metal layer not entirely but only partially on the film surface, a method where a plating resist is formed to have a desired pattern on the metal thin film, the metal layer is grown in the resist-free portion by electroplating utilizing the metal thin film layer as the electric power supply element, then the plating resist is removed, and the metal thin film layer, in the portion where the metal layer is not grown by electroplating, is patternwise etched by etching, may be employed. Of course, a resin composite film where a metal is partially formed can be obtained also by a method of, after completing the metal-resin composite film, patternwise etching the metal by utilizing a resist.

In order to enhance the adhesion between the metal layer and the resin B layer, the metal-resin composite film is preferably subjected to a heating (annealing) treatment by using an oven or the like, usually at 50 to 350° C., preferably from 80 to 250° C., and usually for 0.1 to 10 hours, preferably from 0.1 to 5 hours. At this time, the heating is preferably performed in an inert gas atmosphere such as nitrogen or argon. Furthermore, if desired, the metal-resin composite film at the heating may be pressurized by a pressing plate, a pressure roll or the like.

The metal-resin composite film of the present invention (hereinafter referred to as a “wiring film”) where a metal layer is patternwise formed by the above-described method is suitably used as a wiring film for a semiconductor package or a film for a flexible printed circuit by forming a terminal plating or a protective film for using the wiring film as a circuit board. Furthermore, the metal-resin composite film of the present invention, where a metal layer is patternwise formed by the above-described method, can also be suitably used for a multilayer circuit board by using the wiring film as an inner layer circuit.

In addition, this wiring film is effectively used as a high-reliability circuit component by mounting a passive device or an active device.

More specifically, the wiring film is usable in various uses, for example, as a flexible printed circuit (FPC) for the connection of a printed circuit used in a portable information device such as electronic notebook, personal computer, cellular phone and PHS or in a device such as digital camera and camcorder; as a tape for tape automated bonding (TAB); as a high-density flexible printed circuit such as chip-on-film (COF) and system-on-film (SOF); as a carrier film or base film of a semiconductor package such as tape carrier package (TCP) and chip size package (CSP); and as an inner layer material of a high-density multilayer wiring for a package such as system-in-package, multi-chip module and ball grid array. In particular, the wiring film is effective as a COF and an SOF where a bare chip is mounted under high temperature and applied pressure, and as a wiring plate for various packages.

### EXAMPLES

The present invention is described in greater detail below by referring to Examples and Comparative Examples. In Examples, unless otherwise indicated, the “parts” and “%” are on the mass basis.

The evaluation methods performed in Examples are as follows.

(1) Molecular Weight (Mw, Mn)

The molecular weight was measured by gel permeation chromatography (GPC) using toluene as the solvent and expressed in terms of polystyrene.

(2) Hydrogenation Ratio and Maleic Anhydride Residue Content

The hydrogenation ratio based on the molar number of the unsaturated bond in the polymer before hydrogenation and the ratio of the molar number of maleic anhydride residue based on the total number of monomer units each was measured by the ¹H-NMR spectrum.

(3) Glass Transition Temperature (Tg)

The glass transition temperature was measured by the differential scanning calorimetry (DSC method).

(4) Evaluation of Ten-Point Average Roughness Rzjis

As for the ten-point average roughness Rzjis of the resin B layer surface, the surface roughness of a square region of 20 μm×20 μm was measured by using a non-contact optical surface profile measuring apparatus (color laser microscope VK-8500, manufactured by Keyence) and the ten-point average roughness was determined. This measurement was performed at 5 portions and the average thereof was evaluated as Rzjis.

(5) Evaluation of Average Roughness Ra

As for the average roughness Ra of the resin B layer surface, the surface roughness of a square region of 20 μm×20 μm was measured at 5 portions by using a non-contact optical surface profile measuring apparatus (color laser microscope VK-8500, manufactured by Keyence Corp.) and the average thereof was evaluated as the surface roughness Ra of the resin surface.

(6) Flexibility Test

This test was performed according to JIS K 5400 by using a flexibility tester having a mandrel diameter of 3 mm and an accessory plate thickness of 3.5 mm. The composite film was bent at 180° such that the resin B layer face came outside with respect to the mandrel and the appearance was evaluated by using an optical microscope. The flexibility was rated “++” when cracking or separation was not recognized in the resin B layer, and rated “−” when cracking or separation was recognized.

(7) Evaluation of Pattern Profile

A wiring film having a wiring pattern comprising 50 wirings with a wiring width of 30 μm, an inter-wiring distance of 30 μm and a wiring length of 5 cm was formed. The pattern profile was rated “++” when 50 wirings all had no disorder in the profile, rated “+” when the profile was disordered but not defective, and rated “−” when defective.

(8) Evaluation of Wiring Adhesion after High-Temperature Humidification

The same wiring film as used in (7) was continuously left standing in a thermo-hygrostat kept at 85° C. and 85% RH for 300 hours. Thereafter, the peel strength at 90° was measured according to JIS C 5016. The wiring adhesion was rated “−” when less than 0.1 kN/m, rated “+” when more than 0.1 kN/m to 0.3 kN/m, and rated “++” when more than 0.3 kN/m.

(9) Test of Insulation Reliability

A wiring pattern having thereon a comb-type pattern with a wiring width of 20 μm, an inter-wiring distance of 20 μm and a length of 1 cm was formed and while applying a direct current voltage of 40 V thereto, continuously left standing in a thermo-hygrostat kept at 85° C. and 85% RH for 1,000 hours. The insulating reliability was rated “++” when the electric resistance was 10⁹ ohm or more even after the passage of 1,000 hours, rated “+” when from 10⁸ ohm to less than 10⁹ ohm, and rated “−” when less than 10⁸ ohm.

(10) Test of High-Temperature Mounting Property

An Ni—Au plated semiconductor chip having a width and a length both of 35 μm and a thickness of 16 μm, in which a bump was formed, was placed on a wiring film having formed thereon 300 lead (wiring) patterns each having a wiring width of 20 μm and a wiring length of 500 μm at an inter-wiring distance of 20 μm by using an inner lead bonder (ILT-100, manufactured by Shinkawa Ltd.) so that the bump could be superposed on the position allowing 5 μm from the end of the lead pattern to protrude, and pressed under heating for 0.5 seconds. The heating temperature was 300° C. as the tool temperature and 300° C. as the stage temperature. The pressure applied was 18 mg/μm² in terms of the load applied per area of the lead pattern coming into contact with the bump. The high-temperature mounting property was rated “++” when lifting or separation of the protruded lead pattern was not generated or lifting or separation was 0.5 μm or less from the film surface, rated “+” when lifting or separation of the lead was from more than 0.5 μm to 1 μm, and rated “−” when lifting or separation of the lead was more than 1 μm.

(11) Measurement of Water Absorptivity with 10 μm-Thick Film

If the weight when the specimen shaped into a film form having a size of 3 cm×3 cm and a thickness of 10 μm was dried in an oven at 105° C. for 2 hours and then cooled to room temperature in a desiccator is W0 and the weight when this sample was subsequently dipped in distilled water at 25° C. and after 24 hours, pulled up from water, wiped with a dry cloth and immediately weighed is W1, the water absorptivity represented by the following formula 1 can be determined using the following formula.
Water absorptivity=[(W1-W0)/W0]×100 (formula 1)
(12) Measurement of Tensile Elongation at Break

This is a value determined by preparing a specimen of Type 2 shape (thickness: 10 μm, width: 5 mm, length: 70 mm) and measuring the specimen according to the test method prescribed in JIS K 7127-1999 with an inter-marker distance of 50 mm, an initial distance of 50 mm between chucks and a test speed of 20±2.0 mm/min.

### Example 1

8-Ethyl-tetracyclo[4.4.0.1^{2,5}.1^{7,10}]-dodec-3-ene was ring-opening polymerized and the polymer was then subjected to a hydrogenation reaction to obtain a hydrogenated polymer having a number average molecular weight (Mn)=31,200, a weight average molecular weight (Mw)=55,800 and Tg=about 140° C. The hydrogenation ratio of the obtained polymer was 99% or more.

100 Parts of the obtained polymer, 40 parts of maleic anhydride and 5 parts of dicumyl peroxide were dissolved in 250 parts of tert-butylbenzene and allowed to react at 140° C. for 6 hours. The reaction product solution obtained was poured in 1,000 parts of isopropyl alcohol to precipitate the reaction product, thereby obtaining a maleic acid-modified hydrogenated polymer. This modified hydrogenated polymer was dried in vacuum at 100° C. for 20 hours. The molecular weight of this modified hydrogenated polymer was Mn=33,200 and Mw=68,300, and Tg was 170° C. The maleic anhydride residue content was 25 mol %. The percentage mass change after dipping the modified hydrogenated polymer in an aqueous sodium hydroxide solution was measured by the above-described method according to JIS K7114:2001. As a result, the percentage mass change of the modified hydrogenated polymer obtained was in the range from 0.05 to 0.3%.

100 Parts of the modified hydrogenated polymer as the insulating polymer, 40 parts of bisphenol A bis(propylene glycol glycidyl ether)ether as the curing agent, 5 parts of 2-[2-hydroxy-3,5-bis(α,α-dimethylbenzyl)phenyl]benzotriazole as the ultraviolet absorbent, 0.1 part of 1,3,5-tris(3,5-di-tert-butyl-4-hydroxybenzyl)-1,3,5-triazine-2,4,6(1H, 3H, 5H)trione as the antioxidant, and 10 parts of liquid polybutadiene (Nisseki Polybutadiene B-1000, trade name, produced by Nippon Petrochemicals Co., Ltd.) as the resin soluble in an oxidizing treatment solution were dissolved in a mixed solvent consisting of 374 parts of xylene and 94 parts of cyclopentanone to obtain an insulating material varnish.

This varnish was continuously applied on a plasma-treated polyimide film (Kapton 150EN, trade name, produced by Du Pont-Toray Co., Ltd.) having a width of 400 mm and a thickness of 37.5 μm and, at the same time, continuously dried at a speed allowing for a stay in a zone at 110° C. for 2 minutes to obtain a resin A layer having thereon a resin layer. The resin A layer obtained was taken up into a roll. When the resin layer formed on the obtained composite film was dipped in a mixed solvent consisting of 80 parts of xylene and 20 parts of cyclopentanone at room temperature for 24 hours, the resin layer was completely dissolved. From this, it was confirmed that this resin layer was an uncured resin layer.

Subsequently, the obtained resin A layer having thereon a resin layer was dipped and allowed to stay in a 1% aqueous solution of 1-(2-aminoethyl)-2-methylimidazole at 30° C. for 10 minutes (surface treatment step), then dipped in water at 25° C. for 1 minute (washing step) and after removing the excess solution by an air knife, continuously treated to be exposed at 60° C. for 10 minutes and further at 180° C. for 30 minutes in a heating furnace subjected to flowing nitrogen purge of the inside (curing step), thereby obtaining a resin composite film comprising a resin A layer and a resin B layer having a thickness of 3 μm. The resin composite film obtained was taken up into a roll. Using a part of this resin composite film, a flexibility test was performed. The result is shown in Table 1.

The resin composite film in the roll form was unrolled and, along therewith, the resin composite film was dipped in an aqueous solution adjusted to a permanganic acid concentration of 60 g/liter and a sodium hydroxide concentration of 28 g/liter at 70° C. for 10 minutes and then washed with water by dipping it in a water bath for 1 minute and further in another water bath for 1 minute. Subsequently, the resin composite film was subjected to a neutralization-reduction treatment of dipping it in an aqueous solution having a hydroxylamine sulfate concentration of 170 g/liter and a sulfuric acid concentration of 80 g/liter at 25° C. for 5 minutes, and then dipped in a water bath for 1 minute, thereby effecting water washing.

Thereafter, as the plating pretreatment, the resin composite film after water washing was dipped in a Pd salt-containing plating catalyst solution having a PC-65H (produced by Ebara-Udylite Co., Ltd.) concentration of 250 ml/liter and an SS-400 (produced by Ebara-Udylite Co., Ltd.) concentration of 0.8 ml/liter at 50° C. for 5 minutes. After that, the resin composite film was washed with water and then dipped in a solution prepared to have a PC-66H (produced by Ebara-Udylite Co., Ltd.) concentration of 10 ml/liter and a PC-BA (produced by Ebara-Udylite Co., Ltd.) concentration of 14 g/liter at 35° C. for 5 minutes, thereby reducing the plating catalyst.

The resin B layer surface of the resin composite film of which plating pretreatment was thus completed was subjected to measurements of the ten-point average roughness Rzjis and the average surface roughness Ra. The results are shown in Table 1.

Subsequently, as the electroless plating treatment, the resin composite film after the plating pretreatment was dipped in an electroless plating solution having a PB-556MU (produced by Ebara-Udylite Co., Ltd.) concentration of 20 ml/liter, a PB-556A (produced by Ebara-Udylite Co., Ltd.) concentration of 60 ml/liter, a PB-556B (produced by Ebara-Udylite Co., Ltd.) concentration of 60 ml/liter, and a PB-556C (produced by Ebara-Udylite Co., Ltd.) concentration of 60 ml/liter at 35° C. for 4 minutes while blowing air thereinto, thereby forming a metal thin film layer having a thickness of 0.1 μm. The film in which a metal thin film layer was formed by electroless plating was washed with water, subjected to rust preventive treatment, further washed with water and then blow-dried to obtain a film having formed thereon a metal thin film layer.

The steps from the oxidation treatment of the resin B layer until the film having formed thereon a metal thin film layer was obtained, were all performed by continuously unrolling the film obtained in the previous step and after the rust preventive step, the film was taken up to obtain a rolled film having formed thereon a metal thin film layer. Also, from the oxidation treatment to the electroless plating treatment, the film was kept in the wetted state without drying.

The film having formed thereon a metal thin film layer, after the rust preventive treatment, was dipped in a solution having a sulfuric acid concentration of 100 g/liter at 25° C. for 1 minute to remove the rust inhibitor and then subjected to electroplating in a copper sulfate plating solution having a SUPERTHROW 2000 (produced by Enthone Japan LTD., for copper sulfate plating) concentration of 985 ml/liter and a SUPERTHROW 2000 (produced by Enthone Japan Ltd., brightening agent for copper sulfate plating) concentration of 15 ml/liter at 23° C. while supplying electric power at 3 A/dm³ through an electric power supply roll, to form an electrolytic copper plating film having a thickness of 8 μm. Subsequently, the film on which the metal layer was completed by the electrolytic copper plating was washed with water, subjected to rust preventive treatment, again washed with water, then blow-dried and allowed to stay in a heated furnace at 170° C. for 30 minutes, thereby effecting annealing treatment. In this way, a metal-resin composite film was obtained.

The steps from the removal of rust inhibitor to the annealing treatment were performed by continuously unrolling the film obtained in the previous step and after the annealing treatment, the metal-resin composite film was taken up, whereby a rolled metal-resin composite film was obtained.

The thus-obtained metal-resin composite film was cut into a size necessary for evaluation of a pattern profile, an evaluation of adhesion after high-temperature humidification, an evaluation of insulating reliability and an evaluation of high-temperature mounting property on each wiring film were obtained. A commercially available photosensitive resist dry film was laminated by heat-bonding on the metal layer surface of the metal-resin composite film cut out, and a mask corresponding to each pattern for various evaluations was contacted on the dry film and after exposure, developed to obtain a resist pattern. Subsequently, the rust inhibitor was removed by dipping in a solution having a sulfuric acid concentration of 100 g/liter at 25° C. for 1 minute, and the copper in the resist-free portion was etched with a mixed solution of cupric chloride and hydrochloric acid. Thereafter, the resist pattern was separated and removed by a separation solution, and the film was washed with water and dried to obtain a wiring film. Using the obtained wiring film, each evaluation was performed. The evaluation results are shown in Table 1.

Also, the insulating material varnish prepared above was coated on a polytetrafluoroethylene, dried and cured under heating to form a film. After that, the film was separated from the polytetrafluoroethylene to obtain a film having a thickness of 10 μm. Using this as a specimen, the water absorptivity and tensile elongation at break were evaluated. The evaluation results are shown in Table 1.

### Example 2

A resin composite film, a metal-resin composite film, various wiring films and a specimen were prepared in the same manner as in Example 1 except for changing the conditions of the microgravure coater to form a resin B layer having a thickness of 1 μm, and various evaluations were performed. The evaluation results are shown in Table 1.

### Comparative Example 1

### Comparison of Thickness of Resin B Layer

A resin composite film, a metal-resin composite film, various wiring films and a specimen were prepared in the same manner as in Example 1 except for changing the conditions of the microgravure coater to form a resin B layer having a thickness of 5 μm, and various evaluations were performed. The evaluation results are shown in Table 1.

### Comparative Example 2

### When Water Absorptivity with 10 μm-Thick Film of Resin B Layer is High

A resin composite film, a metal-resin composite film, various wiring films and a specimen were prepared in the same manner as in Example 1 except that 80 parts of epoxy resin (Epikote 1000, trade name, produced by Yuka-Shell Epoxy Co., Ltd., Mw=1,300) and 40 parts of polyamide resin MACROMETRE 6217 (produced by Henkel Hakusui Corp.) were used in place of 100 parts of modified hydrogenated polymer used in Example 1 and the film was not dipped in a 1% aqueous solution of 1-(2-aminoethyl)-2-methylimidazole. The evaluation results are shown in Table 1. Incidentally, when the epoxy resin above was exposed in a high-temperature alkali bath by the same method as in Example 1, the percentage mass change exceeded 0.8%.

### Comparative Example 3

### When Water Absorptivity of Resin B Layer is Too Low

A composite film comprising a polyimide and an inorganic insulating film was obtained by forming a silicon oxide film to a thickness of 0.2 μm by sputtering on a plasma-treated polyimide film (Kapton 200EN, trade name, produced by Du Pont-Toray Co., Ltd.) having a width of 400 mm and a thickness of 40 μm.

The water absorptivity of the inorganic insulating film was measured by the above-described method using a sample obtained by forming a 10 μm-thick silicon oxide film by sputtering on a 0.1 mm-thick copper plate, removing the copper in an ammonium persulfate solution having a concentration of 1 mol/liter at 60° C., and water-washing and then drying the film. The evaluation result is shown in Table 1. Also, Rzjis and Ra on the inorganic insulating film surface of the obtained composite film were measured. The results are shown in Table 1.

Separately from this, on the inorganic resin B layer surface of the composite film comprising a polyimide and an inorganic insulating film, copper was sputtered to form a copper thin film layer having a thickness of 0.1 μm. Thereafter, electrolytic copper plating was applied by utilizing the copper thin film layer while supplying electric power under the condition of 3 A/dm³ through an electric power supply roll, to form an electrolytic copper plating film having a thickness of 8 μm, whereby a metal-resin composite film comprising a polyimide, an inorganic insulating film and a metal layer was obtained. Using this metal-resin composite film, various wiring films and a specimen were obtained in the same manner as in Example 1 and each test was performed, but the inorganic insulating film was separated from the polyimide and therefore, the insulation reliability test could not be performed. Other test results are shown in Table 1.

TABLE 1

| | Example | | Comparative Example | | |
|---|---|---|---|---|---|
| | 1 | 2 | 1 | 2 | 3 |
| Thickness of Resin B | 3 | 1 | 5 | 10 | 0.2 |
| Layer | | | | | |
| Rzjis (μm) | 0.6 | 0.5 | 0.9 | 3.2 | 0.3 |
| Ra (μm) | 0.07 | 0.08 | 0.07 | 0.80 | 0.01 |
| Flexibility | ++ | ++ | ++ | ++ | − |
| Pattern Profile | ++ | ++ | ++ | − | ++ |
| Wiring Adhesion after | ++ | ++ | ++ | − | − |
| High-Temperature | | | | | |
| Humidification | | | | | |
| Insulation Reliability | ++ | ++ | ++ | − | |
| High-Temperature | ++ | ++ | − | − | ++ |
| Mounting Property | | | | | |
| Water Absorptivity (%) | 0.16 | 0.16 | 0.16 | 1.50 | 0.001 |
| Tensile Elongation at | 8.9 | 8.9 | 8.9 | 4.3 | 0.01 |
| Break (%) | | | | | |

As seen from the results above, the resin composite film of the present invention has excellent balance among flexibility, insulation reliability and high-temperature mounting property, the flexible printed circuit and the semiconductor package board each produced by using the film allow for formation of a high-density circuit, and the electronic component produced by using the wiring film is excellent in reliability.

1. A resin composite film comprising a resin A layer formed on at least one surface of a resin B layer, wherein the thickness of said resin B layer is from 0.1 to 4 μm, and the insulating material constituting said resin B gives a water absorptivity of 0.03 to 0.25%, when a film thereof having the thickness of 10 μm is formed.

2. The resin composite film according to claim 1, wherein said insulating material gives the tensile elongation at break of 1.5% or more, when the film having the thickness of 10 μm, the width of 5 mm and the length of 70 mm is formed.

3. The resin composite film according to claim 1, wherein the surface of said resin B layer has the surface ten-point average roughness Rzjis of 3 μm or less and the surface average roughness Ra of 0.2 μm or less.

4. A method for producing the resin composite film as claimed in claim 1, comprising:
applying an insulating material comprising an insulating polymer and a curing agent on at least one surface of the resin A layer,
and heating it to form a resin B layer.

5. A method for producing the resin composite film as claimed in claim 1, comprising:
applying the insulating material comprising an insulating polymer and a curing agent on at least one surface of the resin A layer to obtain an uncured or semi-cured resin layer,
bringing a compound having a metal-coordinatable structure into contact with the resin layer,
and heating said resin layer to form the resin B layer.

6. A metal-resin composite film having a metal layer on the surface of the resin B layer of the resin composite film as claimed in claim 1.

7. The metal-resin composite film according to claim 6, wherein said metal layer is formed by a plating method.

8. The metal-resin composite film according to claim 6, wherein said metal layer is formed patternwise.

9. (canceled)

10. An electronic component using the metal-resin composite film as claimed in claim 6.

11. A wiring film for a semiconductor package using the metal-resin composite film as claimed in claim 6.

12. A film for a flexible printed circuit using the metal-resin composite film as claimed in claim 6.

13. A wiring film for a semiconductor chip mounting using the metal-resin composite film as claimed in claim 6.
